(19) United States
(12) Patent Application Publication
(10) Pub. No.: US 2024/0147235 A1
(43) Pub. Date: May 2, 2024

(54) NETWORK SLICE ADMISSION CONTROL

(71) Applicant: Lenovo (Singapore) Pte. Ltd., New Tech Park (SG)

(72) Inventor: Genadi Velev, Darmstadt (DE)

(21) Appl. No.: 18/548,150

(22) PCT Filed: Feb. 28, 2022
(86) PCT No.: PCT/IB2022/051752

§ 371 Date: Aug. 28, 2023

Related U.S. Application Data
(60) Provisional application No. 63/154,583, filed on Feb. 26, 2021.

(51) Int. Cl. H04W 12/06; H04W 12/084

(52) U.S. Cl. CPC H04W 12/06; H04W 12/084

(57) ABSTRACT

Apparatuses, methods, and systems are disclosed for network slice admission control. One method includes receiving, at a first network function (NF), a registration request message including a registration request for a network slice. The network slice is subject to network slice specific secondary authentication and authorization (NSSAA) and network slice admission control. The method includes determining to perform a registration procedure by transmitting a registration accept message to a user equipment (UE). The registration accept message includes pending network slice selection assistance information (NSSAI) including a network slice identity corresponding to the network slice. The method includes transmitting information initiating the NSSAA procedure to the user equipment. The method includes, in response to the NSSAA procedure being successful, transmitting an availability check message for network slice admission control to a second NF.

### CROSS-REFERENCE TO RELATED APPLICATIONS

This application claims priority to U.S. Patent Application Ser. No. 63/154,583 entitled “APPARATUSES, METHODS, AND SYSTEMS FOR UPDATING THE STATUS FOR NETWORK SLICE ADMISSION CONTROL” and filed on Feb. 26, 2021 for Genadi Valev, which is incorporated herein by reference in its entirety.

### FIELD

The subject matter disclosed herein relates generally to wireless communications and more particularly relates to network slice admission control.

### BACKGROUND

In certain wireless communications networks, network slice admission control may be used. In such networks, an access and mobility management function may not support network slice admission control.

### BRIEF SUMMARY

Methods for network slice admission control are disclosed. Apparatuses and systems also perform the functions of the methods. One embodiment of a method includes receiving, at a first network function (NF), a registration request message including a registration request for a network slice. The network slice is subject to network slice specific secondary authentication and authorization (NSSAA) and network slice admission control. In some embodiments, the method includes determining to perform a registration procedure by transmitting a registration accept message to a user equipment (UE). The registration accept message includes pending network slice selection assistance information (NSSAI) including a network slice identity corresponding to the network slice. In certain embodiments, the method includes transmitting information initiating the NSSAA procedure to the user equipment. In various embodiments, the method includes, in response to the NSSAA procedure being successful, transmitting an availability check message for network slice admission control to a second NF.

One apparatus for network slice admission control includes a first network function (NF). In some embodiments, the apparatus includes a receiver that receives a registration request message including a registration request for a network slice. The network slice is subject to network slice specific secondary authentication and authorization (NSSAA) and network slice admission control. In various embodiments, the apparatus includes a processor that determines to perform a registration procedure by transmitting a registration accept message to a user equipment (UE). The registration accept message includes pending network slice selection assistance information (NSSAI) including a network slice identity corresponding to the network slice. In certain embodiments, the apparatus includes a transmitter that: transmits information initiating the NSSAA procedure to the user equipment; and, in response to the NSSAA procedure being successful, transmits an availability check message for network slice admission control to a second NF.

Another embodiment of a method for network slice admission control includes receiving, at a third network function (NF), a request from a user equipment (UE) to establish a protocol data unit (PDU) session associated with network slice selection assistance information (NSSAI). In some embodiments, the method includes determining, at the third NF, whether to perform a secondary authentication for the PDU session. In certain embodiments, the method includes, in response to determining to perform the secondary authentication, performing the secondary authentication for the PDU session. In various embodiments, the method includes, in response to the secondary authentication being successful, transmitting an availability check message for network slice admission control to a second NF.

Another apparatus for network slice admission control includes a third network function (NF). In some embodiments, the apparatus includes a receiver that receives a request from a user equipment (UE) to establish a protocol data unit (PDU) session associated with network slice selection assistance information (NSSAI). In various embodiments, the apparatus includes a processor that: determines, at the third NF, whether to perform a secondary authentication for the PDU session; and, in response to determining to perform the secondary authentication, performs the secondary authentication for the PDU session. In certain embodiments, the apparatus includes a transmitter that, in response to the secondary authentication being successful, transmits an availability check message for network slice admission control to a second NF.

A further embodiment of a method for network slice admission control includes transmitting, from a user equipment (UE), a registration request message to a first network function (NF). In some embodiments, the method includes receiving a registration accept message from the first NF. The registration accept message includes network slice selection assistance information (NSSAI). In certain embodiments, the method includes receiving information initiating a network slice specific authentication and authorization (NSSAA) procedure to the user equipment.

A further apparatus for network slice admission control includes a user equipment. In some embodiments, the apparatus includes a transmitter that transmits, from the UE, a registration request message to a first network function (NF). In various embodiments, the apparatus includes a receiver that: receives a registration accept message from the first NF, wherein the registration accept message includes network slice selection assistance information (NSSAI); and receives information initiating a network slice specific authentication and authorization (NSSAA) procedure to the user equipment.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be to considered to be limiting of scope, the embodiments will be described and explained with additional specificity and detail through the use of the accompanying drawings, in which:

FIG. 1 is a schematic block diagram illustrating one embodiment of a wireless communication system for network slice admission control;

FIG. 2 is a schematic block diagram illustrating one embodiment of an apparatus that may be used for network slice admission control;

FIG. 3 is a schematic block diagram illustrating one embodiment of an apparatus that may be used for network slice admission control;

FIG. 4 is a schematic block diagram illustrating one embodiment of a system for UE mobility with an AMF change to an AMF that does not support an NSAC feature;

FIG. 5 is a schematic block diagram illustrating one embodiment of a system including a number of UEs per network slice availability check procedure;

FIG. 6 is a schematic block diagram illustrating one embodiment of a system including a number of UEs per network slice update procedure;

FIG. 7 is a schematic block diagram illustrating one embodiment of a system for UE mobility with an AMF change and a new AMF (e.g., second AMF, AMF1) sending an indication to an old AMF (e.g., first AMF, AMF2) about the unsupported S-NSSAIs;

FIG. 8 is a flow chart diagram illustrating one embodiment of a method for if the S-NSSAI is subject to both NSSAA and NSAC for a maximum number registered UEs;

FIG. 9 is a flow chart diagram illustrating one embodiment of a method for if the S-NSSAI is subject to both SAA and NSAC for a maximum number of established PDU sessions;

FIGS. 10A through 10B are schematic block diagrams illustrating one embodiment of a system for performing a registration procedure;

FIG. 11 is a flow chart diagram illustrating one embodiment of a method for network slice admission control;

FIG. 12 is a flow chart diagram illustrating another embodiment of a method for network slice admission control; and

FIG. 13 is a flow chart diagram illustrating a further embodiment of a method for network slice admission control.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

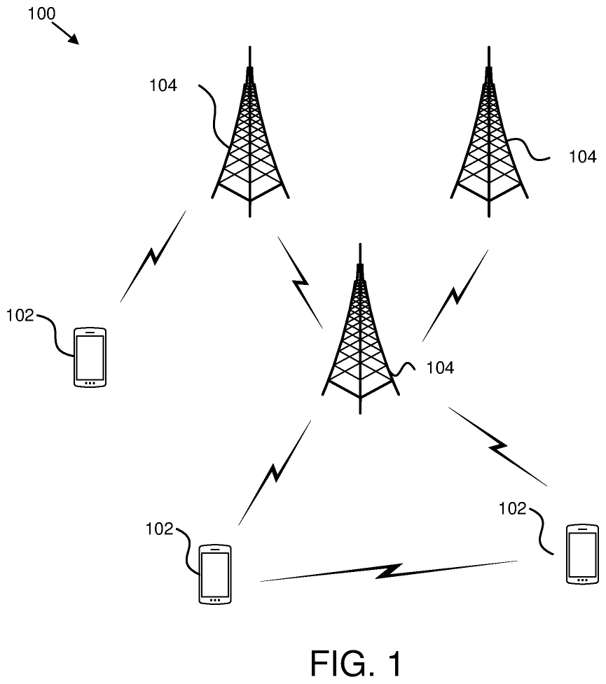

FIG. 1 depicts an embodiment of a wireless communication system 100 for network slice admission control. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In certain embodiments, a network unit 104 may receive, at a first network function (NF), a registration request message including a registration request for a network slice. The network slice is subject to network slice specific secondary authentication and authorization (NSSAA) and network slice admission control. In some embodiments, the network unit 104 may determine to perform a registration procedure by transmitting a registration accept message to a user equipment (UE). The registration accept message includes pending network slice selection assistance information (NSSAI) including a network slice identity corresponding to the network slice. In certain embodiments, the network unit 104 may transmit information initiating the NSSAA procedure to the user equipment. In various embodiments, the network unit 104 may, in response to the NSSAA procedure being successful, transmit an availability check message for network slice admission control to a second NF. Accordingly, the network unit 104 may be used for network slice admission control.

In some embodiments, a network unit 104 may receive, at a third network function (NF), a request from a user equipment (UE) to establish a protocol data unit (PDU) session associated with network slice selection assistance information (NSSAI). In some embodiments, the network unit 104 may determine, at the third NF, whether to perform a secondary authentication for the PDU session. In certain embodiments, the network unit 104 may, in response to determining to perform the secondary authentication, perform the secondary authentication for the PDU session. In various embodiments, the network unit 104 may, in response to the secondary authentication being successful, transmit an availability check message for network slice admission control to a second NF. Accordingly, the network unit 104 may be used for network slice admission control.

In various embodiments, a remote unit 102 may transmit, from a user equipment (UE), a registration request message to a first network function (NF). In some embodiments, the remote unit 102 may receive a registration accept message from the first NF. The registration accept message includes network slice selection assistance information (NSSAI). In certain embodiments, the remote unit 102 may receive information initiating a network slice specific authentication and authorization (NSSAA) procedure to the user equipment. Accordingly, the remote unit 102 may be used for network slice admission control.

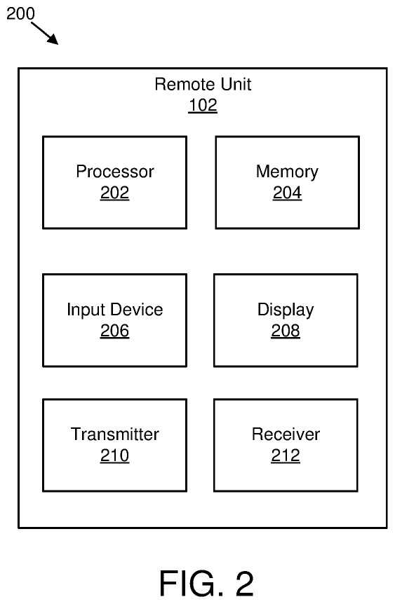

FIG. 2 depicts one embodiment of an apparatus 200 that may be used for network slice admission control. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the transmitter 210 transmits, from the UE, a registration request message to a first network function (NF). In various embodiments, the receiver 212: receives a registration accept message from the first NF, wherein the registration accept message includes network slice selection assistance information (NSSAI); and receives information initiating a network slice specific authentication and authorization (NSSAA) procedure to the user equipment.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

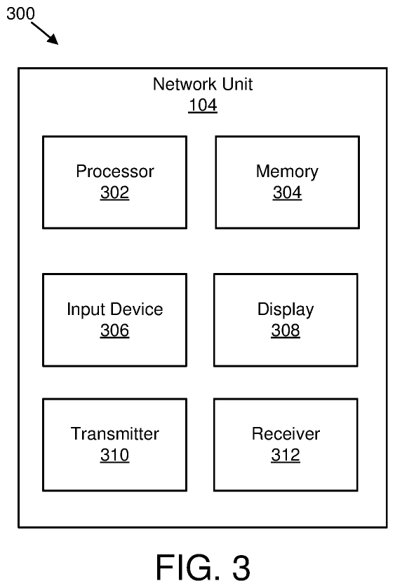

FIG. 3 depicts one embodiment of an apparatus 300 that may be used for network slice admission control. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives a registration request message including a registration request for a network slice. The network slice is subject to network slice specific secondary authentication and authorization (NSSAA) and network slice admission control. In various embodiments, the processor 302 determines to perform a registration procedure by transmitting a registration accept message to a user equipment (UE). The registration accept message includes pending network slice selection assistance information (NSSAI) including a network slice identity corresponding to the network slice. In certain embodiments, the transmitter 310: transmits information initiating the NSSAA procedure to the user equipment; and, in response to the NSSAA procedure being successful, transmits an availability check message for network slice admission control to a second NF.

In some embodiments, the receiver 312 receives a request from a user equipment (UE) to establish a protocol data unit (PDU) session associated with network slice selection assistance information (NSSAI). In various embodiments, the processor 302: determines, at the third NF, whether to perform a secondary authentication for the PDU session; and, in response to determining to perform the secondary authentication, performs the secondary authentication for the PDU session. In certain embodiments, the transmitter 310, in response to the secondary authentication being successful, transmits an availability check message for network slice admission control to a second NF.

In certain embodiments, a network slice customer (e.g., a vertical or service provider) may negotiate or request network slice characteristics from a network operator deploying a network slice. The network slice characteristics may be identified by network slice attributes. In some embodiments, a generic network slice template (“GST”) may be used by a network operator to derive network slice characteristics.

In various embodiments, there may be a network feature called a network slice admission control (“NSAC”).

In certain embodiments, a network function (“NF”) may be used for management of network slice attributes in a control plane of a network (e.g., fifth generation(“5G”) core (“5GC”)). Such a NF may be called a network slice admission control function (“NSACF”) and may be responsible for: 1) being aware that one or more network slice attributes are to be monitored and including possible quotas that need to be enforced; 2) collecting information from other NFs about the network slice attributes to be monitored; and/or 3) roaming aspects that need to be considered.

In some embodiments, a second AMF (AMF2) supports an NSAC feature, and a first AMF (AMF1) does not support the NSAC feature (e.g., it may not serve any single (“S”) network slice selection assistance information (“NSSAI”) (“S-NSSAI”) subject to NSAC).

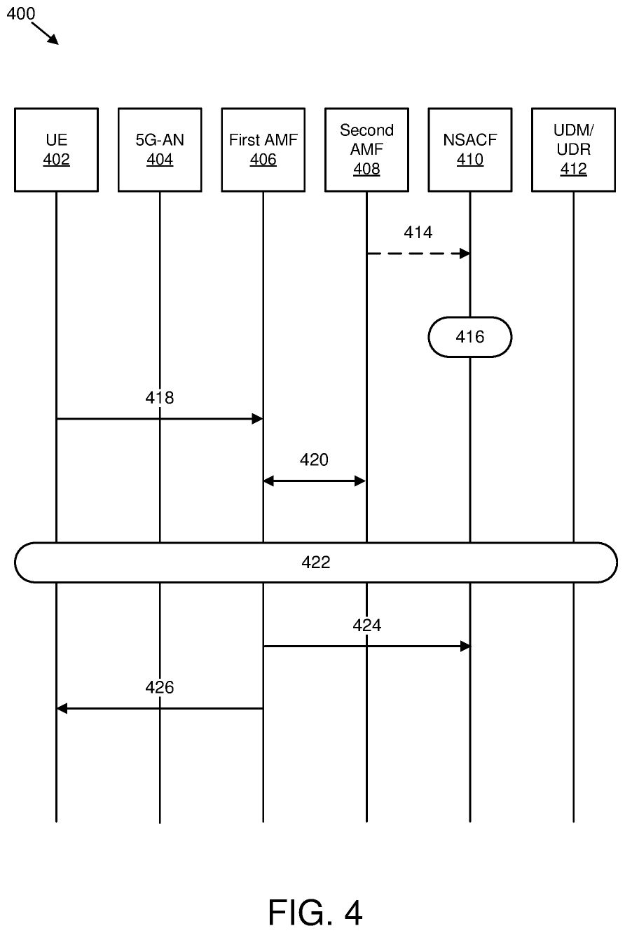

FIG. 4 is a schematic block diagram illustrating one embodiment of a system 400 for UE mobility with an AMF change to an AMF that does not support an NSAC feature. The system 400 includes a UE 402, a 5G access network (“AN”) (“5G-AN”) 404, a first AMF 406, a second AMF 408, an NSACF 410, and a UDM/UDR 412. Each communication in the system 400 may include one or more messages.

In a first communication 414, the second AMF 408 may send a message to the NSACF 410.

The NSACF 410 may store 416 status information indicating that the UE 402 is registered with a S-NSSAI.

In a second communication 418, the UE 402 may transmit a registration request (e.g., 5G-GUTI) to the first AMF 406.

In a third communication 420, communications between the first AMF 406 and the second AMF 408 may include a UE context transfer (e.g., 5G-GUTI).

In a fourth communication 422, security procedures may be performed among devices.

In a fifth communication 424 (e.g., attempted communication), the first AMF 406 may be unable to communicate with the NSACF 410.

In a sixth communication 426, the first AMF 406 may transmit a registration accept message to the UE 402.

As shown in FIG. 4, during UE mobility with an AMF change, the new AMF (e.g., first AMF 406) is not NSAC capable and cannot inform the NSACF 410 that a terminal (e.g., UE) is not registered anymore with the S-NSSAI. In such an embodiment, it may be unclear about how the NSACF 410 is informed that the UE is not any longer registered with the S-NSSAI.

In some embodiments, if an S-NSSAI is subject to both NSSAA and NSAC, it may be unclear about which procedure is performed first and which is an optimal behavior not causing problems with false counting in the NSACF. For example, if the AMF first updates the NSACF and the following NSSAA procedure fails, the AMF needs to update the NSACF again. Such double interaction (e.g., update) with between AMF and NSACF for the same S-NSSAI and the same UE may be avoided.

In various embodiments, a network slice quota (“NSQ”) network function may be used to perform network slice admission control for a maximum number of UEs.

In certain embodiments, network slice admission control function (“NSACF”) procedures may be performed. In such embodiments, the NSACF is with a maximum number of user equipments (“UEs”) that are allowed to be served by a network slice that is subject to NSAC.

The NSACF controls the number of the UEs registered per network slice so that the maximum number of UEs per network slice is not exceeded.

In some embodiments, there is a number of UEs per network slice availability check procedure. The number of UEs per network slice availability check procedure is triggered by an AMF to check whether the maximum number of UEs registered with a network slice subject to NSAC has already been reached. The AMF is configured with the information indicating which network slice is subject to NSAC.

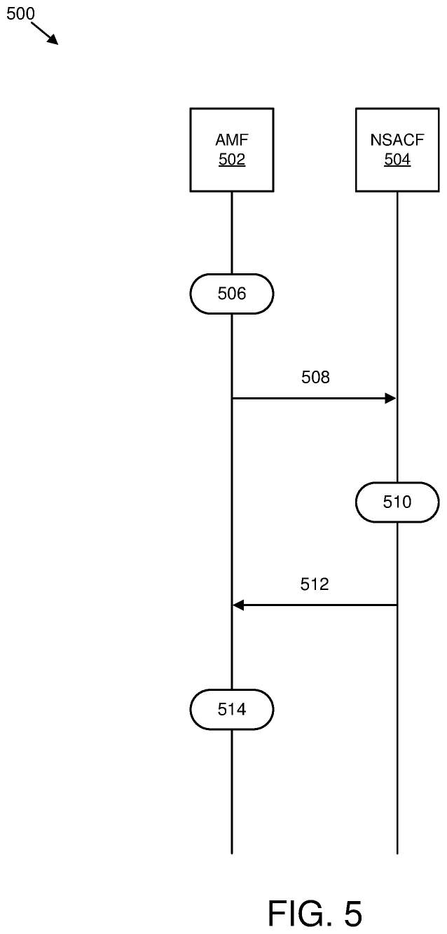

FIG. 5 is a schematic block diagram illustrating one embodiment of a system 500 including a number of UEs per network slice availability check procedure. The system 500 includes an AMF 502 and an NSACF 504. Each of the communications in the system 500 may include one or more messages.

During a UE registration procedure, after the UE is successfully authenticated and authorized, the AMF 502 triggers 506 a request to the NSACF 504 to perform NSAC for each network slice for which the UE is not yet registered but for which the UE requires registration and which is subject to NSAC.

In a first communication 508, the AMF 502 sends a Nnsacf_NumberOfUEsPerSliceAvailabilityCheck_Request message to the NSACF 504. The AMF 502 includes in the message a UE identifier (“ID”) and the S-NSSAIs which are subject to NSAC.

The NSACF 504 checks 510 for each S-NSSAI whether the number of UEs registered with that network slice has already reached the maximum number of UEs per network slice threshold. The NSACF 504 maintains a list of registered UE IDs per network slice for each S-NSSAI that is subject to NSAC. The NSACF 504 checks for each S-NSSAI if the UE ID is already in the list of UEs registered with that S-NSSAI. If the UE ID is in the list of UEs registered with that S-NSSAI, then there is no check if the maximum number of registered UEs has been reached as the UE is already counted as registered with that S-NSSAI. If the UE ID is not in the list of UEs registered with that S-NSSAI and the maximum number of UEs per network slice for that S-NSSAI has already been reached, then the NSACF 504 returns a maximum number of UEs per network slice reached result. Otherwise, the NSACF 504 returns a maximum number of UEs per network slice not reached result.

In a second communication 512, the NSACF returns a Nnsacf_NumberOfUEsPerSliceAvailabilityCheck_Response in which the NSACF 504 includes the S-NSSAIs for which the number of UEs per network slice availability check was done along with a result parameter per S-NSSAI which indicates whether the maximum number of UEs per network slice has already been reached or not reached.

The AMF 502 continues 514 with the UE registration procedure. If all the S-NSSAIs that the UE requested to register for were subject to NSAC and for all of them the NSACF 504 returned the maximum number of UEs per network slice has been reached, the AMF 502 rejects the UE request for registration. In the registration reject message, the AMF 502 includes the rejected S-NSSAIs in the rejected NSSAI list, a reject cause set to ‘maximum number of UEs per network slice reached’ for each S-NSSAI, and optionally a back-off timer. Otherwise, the AMF 502 continues with the registration procedure and in the registration accept message the AMF 502 includes the rejected S-NSSAIs in the rejected NSSAI list for which the NSACF 504 has indicated that the maximum number of UEs per network slice has been reached, a reject cause set to ‘maximum number of UEs per network slice reached’ for each rejected S-NSSAI, and optionally a back-off timer.

In various embodiments, there may be a number of UEs per network slice update procedure. The number of UEs per network slice update procedure is used to update (e.g., increase or decrease) the number of UEs registered with a network slice which is subject to NSAC. The AMF is configured with the information indicating which network slice is subject to NSAC.

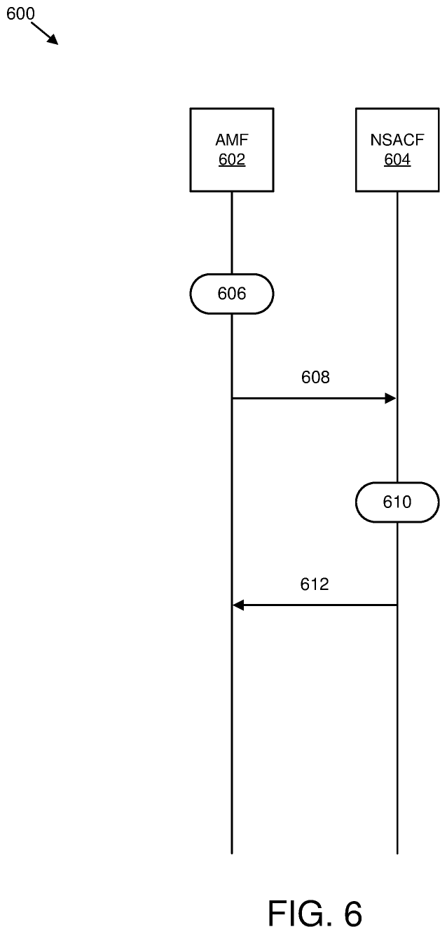

FIG. 6 is a schematic block diagram illustrating one embodiment of a system 600 including a number of UEs per network slice update procedure. The system 600 includes an AMF 602 and an NSACF 604. Each of the communications in the system 600 may include one or more messages.

The AMF 602 triggers 606 a number of UEs per network slice update procedure to update the number of UEs registered with a network slice for the newly registered networks slices that are subject to NSAC based on: 1) a UE registration procedure; 2) a UE deregistration procedure; 3) a network slice-specific authentication and authorization (“NSSAA”); 4) an authentication authorization accounting (“AAA”) server triggered network slice-specific re-authentication and re-authorization procedure; and/or 5) an AAA server triggered slice-specific authorization revocation.

In a first communication 608, the AMF 602 sends a Nnsacf_NumberOfUEsPerSliceUpdate_Request message to the NSACF 604. The AMF 602 includes in the message a UE ID, S-NSSAIs for which the number of UEs registered per network slice update is required, and the number of UEs update flag which indicates whether the number of UEs registered with the S-NSSAIs is to be increased (e.g., after UE registration and NSSAA) or the number of UEs registered with the S-NSSAIs is to be decreased (e.g., after UE deregistration or S-NSSAIs status change from allowed to rejected after AAA server triggered network slice-specific re-authentication and re-authorization procedure or AAA server triggered slice-specific authorization revocation).

The NSACF 604 updates 610 the current number of UEs registered for the S-NSSAI (e.g., increases or decrease the number of UEs per network slice based on the information provided by the AMF 602 in the number of UEs update flag parameter). If the number of UEs update flag parameter from the AMF 602 indicates an increase the current number of UEs per network slice, the NSACF 604 checks if the UE ID is already in the list of UEs registered with the network slice and, if not in the list, the NSACF 604 adds the UE ID to the list of UEs registered with the network slice for each of the S-NSSAIs indicated in the request from the AMF 602 and also the NSACF 604 increases the number of UEs per network slice that is maintained by the NSACF 604 for each of these network slices. Further, if the number of UEs update flag parameter from the AMF 602 indicates a decrease the current number of UEs per network slice, the NSACF 604 removes the UE ID from the list of UEs registered with a network slice for each of the S-NSSAIs indicated in the request from the AMF 602 and also the NSACF 604 decreases the number of UEs per network slice that is maintained by the NSACF 604 for each of these network slices.

In a second communication 512, the NSACF 604 acknowledges the number of UEs per network slice update for each S-NSSAI to the AMF 602.

In certain embodiment, considering UE mobility to a new AMF which does not support one or more S-NSSAIs from current allowed NSSAI, a status in the NSACF may not be updated.

In some embodiments, an S-NSSAI may be a subject to NSAC. The NSAC allows the use of the S-NSSAI resources up to a maximum number of registered UEs and/or a maximum number of established protocol data unit (“PDU”) sessions in the S-NSSAI. If the maximum number of registered UEs and/or established PDU sessions in the S-NSSAI is reached, then new UEs or PDU sessions are rejected.

In various embodiments, NSAC is monitored and controlled by a NSACF. The NSACF and the AMFs serving the S-NSSAI subject to NSAC may perform: 1) an updating (or monitoring) procedure to maintain in the NSACF the current (e.g., total) number of registered UEs or established PDU sessions in the S-NSSAI; and/or 2) an availability check (or admission enforcement) procedure to determine whether to accept or reject UE registration or PDU session establishment according to the configured maximum number of registered UEs and/or established PDU sessions which are allowed to be served by the S-NSSAI subject to NSAC.

First and second embodiments described herein may apply to both NSAC for a maximum number of registered UEs and established PDU sessions, even if only described for the NSAC for the maximum number of registered UEs.

A first embodiment may be for UE mobility with an AMF change. One example is illustrated in FIG. 4 in which a UE moves between cells and/or tracking areas (e.g., in any connection management (“CM”) Idle (“CM-Idle”) or CM connected (“CM-Connected”) state) which results in changing the serving AMF from an old AMF (e.g., AMF2, second AMF) to a new AMF (e.g., AMF1, first AMF). It may be assumed that not all AMFs in a public land mobile network (“PLMN”) support the NSAC feature. In certain embodiments, only an AMF serving S-NSSAI subject to NSAC support the NSAC feature. In some embodiments, the new AMF (AMF1) may not support services to communicate with the NSACF.

In the first embodiment, during UE mobility with AMF change, if the new AMF (e.g., AMF1, first AMF) determines that one or more of the S-NSSAIs contained in an existing allowed NSSAI (e.g., received from the old AMF) are not supported in the new AMF, the new AMF sends an indication to the old AMF with the list of S-NSSAIs (e.g., subject to NSAC) not supported in the new AMF. The old AMF initiates an update procedure with the corresponding NSACFs to update the status in the NSACF (e.g., to reduce the number of UEs or PDU sessions using the S-NSSAI).

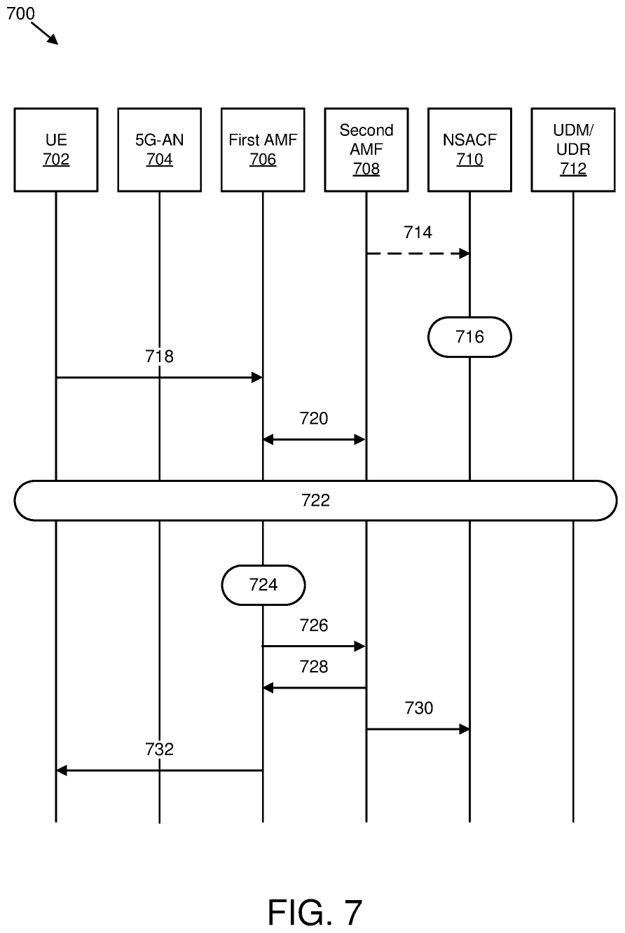

FIG. 7 is a schematic block diagram illustrating one embodiment of a system 700 for UE mobility with an AMF change and a new AMF (e.g., second AMF, AMF1) sending an indication to an old AMF (e.g., first AMF, AMF2) about the unsupported S-NSSAIs. The system 700 includes a UE 702, a 5G-AN 704, a first AMF (AMF1) 706, a second AMF (AMF2) 708, an NSACF 710, and a UDM/UDR 712. Each of the communications in the system 700 include one or more messages.

In a first communication 714, the second AMF 708 may transmit an initial message to the NSACF 710. The NSACF 710 may store 716 a status that the UE is registered with the S-NSSAI.

The UE 702 was registered with the communication system via the AMF2 708. The AMF2 708 has assigned to the UE 702 allowed NSSAI (e.g., containing a list of one or more S-NSSAIs). If one or more of the S-NSSAIs are subject to NSAC, the AMF2 708 has discovered one or more NSACFs serving the S-NSSAIs. The AMF2 708 has sent reports to the NSACFs to update the status that the UE 702 has registered with the S-NSSAI. For NSAC for a maximum number of PDU sessions, an SMF may update the NSACF 710 about the current number of PDU sessions established for the S-NSSAI.

In a second communication 718, the UE 702 sends a non-access stratum (“NAS”) registration request message. The access network (e.g., 5G AN or radio access network (“RAN”)) forwards the message to a selected AMF1 706. The AMF1 706 determines based on the UE ID included in the message (e.g., 5G globally unique temporary identifier (“GUTI”)) that the UE 702 has been registered at the AMF2 708, as the AMF2 708 ID is contained in the 5G GUTI. Therefore, the AMF1 706 decides to request the UE 702 context from the AMF2 708. The registration request message may also contain a requested NSSAI including a list of one or more S-NSSAIs to which the UE 702 wants to register.

In a third communication 720, the AMF1 706 sends Namf_Communication_UEContextTransfer (e.g., complete registration request) to the AMF2 708 to request the UE context. The AMF2 708 sends the UE context to the UE 702 including the current allowed NSSAI. The AMF2 708 replies to the AMF1 706. The AMF2 708 sends to AMF1 706: a response to Namf_Communication_UEContextTransfer (e.g., subscription permanent identifier (“SUPI”), UE context in AMF2 708). The UE context contains among other informational elements (“IEs”) also the allowed NSSAI. In addition, the AMF2 708 sends to AMF1 706 within the UE context the information of which S-NSSAIs of the allowed NSSAI are subject to NSAC. The latter may be needed in the AMF1 706. The AMF2 708 may include this information as an additional list of S-NSSAIs subject to NSAC, or may add a flag to each S-NSSAIs from the allowed NSSAI which are subject to NSAC.

In a fourth communication 722, the AMF1 706 initiates security procedures.

The AMF1 706 determines 724 the new allowed NSSAI for the UE 702 based on the requested NSSAI and the S-NSSAIs supported in the current tracking area (“TA”) and in the AMF1 706. The AMF1 706 compares the created allowed NSSAI with the allowed NSSAI received in the UE context. The AMF1 706 may determine that one or more of the S-NSSAIs subject to NSAC which were included in the allowed NSSAI received in the UE context are not part of the new created allowed NSSAI. In such case, the AMF1 706 determines to send an indication to the AMF2 708 with the list of one or more the S-NSSAIs subject to NSAC which cannot be included in the new allowed NSSAI.

In a fifth communication 726, the AMF1 706 sends an indication to the AMF2 708 with the list of one or more the S-NSSAIs subject to NSAC which cannot be included in the new allowed NSSAI (e.g., the list of S-NSSAIs not supported in the new AMF1 706). For example, the AMF1 706 sends a Namf_Communication_RegistrationStatusUpdate request (e.g., list of S-NSSAIs not supported in the new AMF) service operation including the list of S-NSSAIs not supported in the AMF1 706.

In a sixth communication 728, the AMF2 708 may send an acknowledgement that the fifth communication 726 has arrived.

In a seventh communication 730, the AMF2 708 determines for the received list of S-NSSAIs subject to NSAC and the AMF2 708 performs: 1) if the S-NSSAI is subject to a maximum number of registered UEs, the AMF2 708 sends an update request towards the corresponding NSACFs to inform that the UE 702 is not any longer registered with the S-NSSAI—the NSACF 710 reduces the number of UEs registered with the S-NSSAI; and/or 2) if the S-NSSAI is subject to a maximum number of established PDU sessions, the AMF2 708 triggers the SMFs which serve the PDU sessions associated with the list of S-NSSAIs received from the AMF1 706 to release the PDU sessions autonomously. In certain embodiments herein, autonomously means that the SMF does not need to perform explicit signaling with the UE 702 and 5G-AN 704 and/or RAN to release the PDU sessions. After the SMFs release autonomously the PDU sessions, the SMFs also send a request to the corresponding NSACFs to inform them that the PDU sessions are released (e.g., the NSACF reduces the number of PDU sessions established in the S-NSSAI). For example, if the AMF2 708 sends a Nnsacf_NumberPfUEsPerSliceUpdate_Request message to the NSACF 710. The AMF2 708 may include in the message the UE ID, the S-NSSAI for which the number of UEs registered per network slice update is required and the number of UEs update flag which indicates that the number of UEs registered with the S-NSSAIs is to be decreased.

In the eighth communication 732, the AMF1 706 continues with the registration procedure. Finally, the AMF1 706 sends a registration accept or a registration reject message to the UE 702. The benefits of various embodiments described herein include that the mobility of a UE is enabled from an AMF supporting NSAC to an AMF non-supporting the NSAC. As the new AMF (e.g., AMF1) does not support the NSAC, the new AMF informs the old AMF (e.g., AMF2) that the S-NSSAI subject to NSAC is not supported in the new AMF. As a result, the old AMF can update the NSAC to not count the UE anymore as registered with the S-NSSAI.

In a second embodiment, S-NSSAI may be subject to both NSSAA and NSAC.

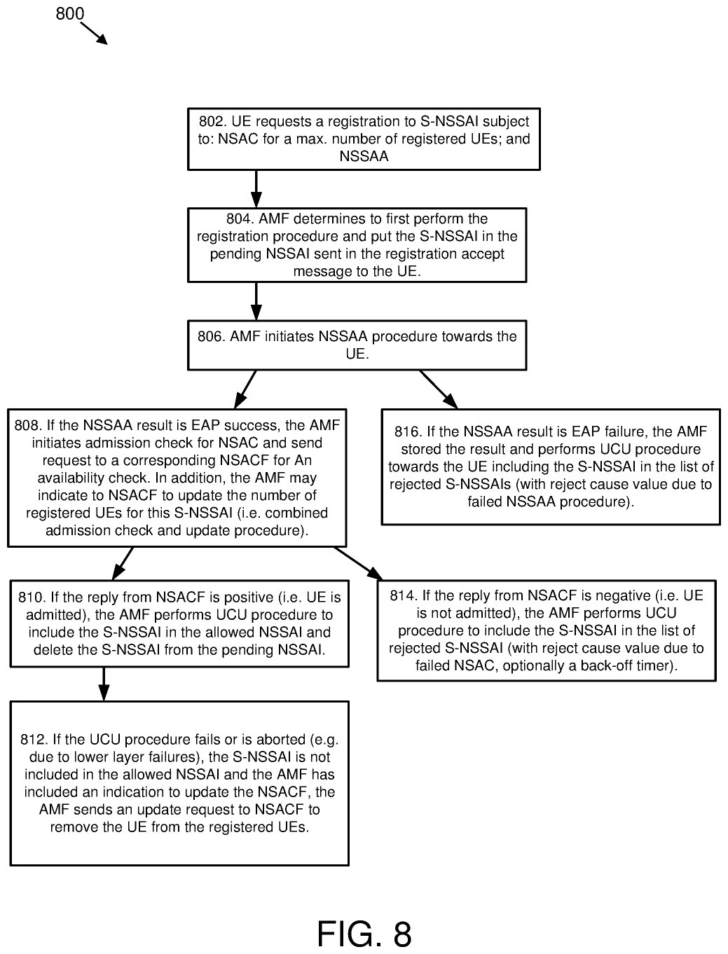

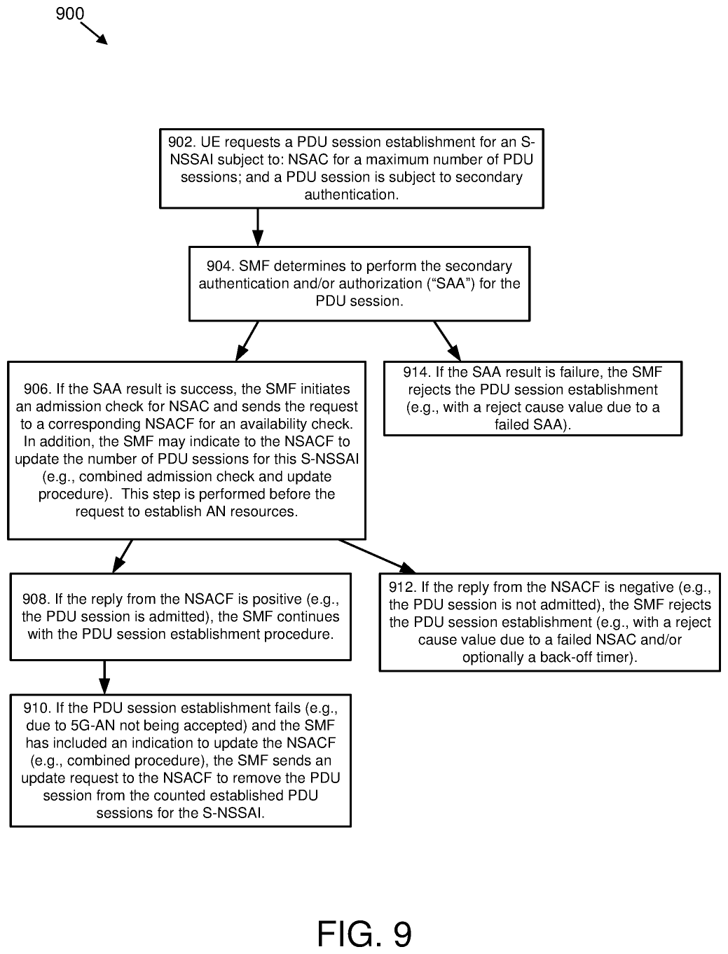

In some embodiments, an admission check (or availability check) procedure and an update procedure are separate procedures. However, if the procedures are performed per UE it may mean that the AMF or SMF need to send 2 requests to the NSACF—one request for admission check, and, if the UE registration or PDU sessions establishment succeeds, another request for update of the current number. If the UE registration or PDU sessions establishment succeed, it can be beneficial to combine both procedures. In other words, a single request from the AMF or SMF to the NSACF can indicate both ‘admission check’ and ‘update’. If the UE registration or PDU sessions establishment procedure fail, the AMF or SMF needs to send an explicit update request to the NSACF to reduce the counter for registered UEs or established PDU sessions in the NSACF. Such combined procedures are illustrated in the FIG. 8 (e.g., for NSAC for maximum number registered UEs) and FIG. 9 (e.g., for NSAC for maximum number of established PDU sessions).

In the second embodiment, if a UE requests a registration to an S-NSSAI, which is subject to both NSSAA and NSAC, the AMF may first wait for the NSAC procedure until the NSSAA procedure is completed. Then, if the NSSAA procedure is successful (e.g., the extensible authentication protocol (“EAP”) result is a ‘Success’), the AMF may perform a combined “availability check” and “update” procedure with a transmission to the NSACF for the NSAC.

In various embodiments, the AMF includes in the registration accept message the pending S-NSSAI and the cause value of NSSAA to be performed. In certain embodiments, the S-NSSAI is subject to NSAC for a maximum number of registered UEs and also subject to NSSAA.

FIG. 8 is a flow chart diagram illustrating one embodiment of a method 800 for if the S-NSSAI is subject to both NSSAA and NSAC for a maximum number registered UEs.

In step 802, a UE requests a registration to S-NSSAI subject to: NSAC for a maximum number of registered UEs; and NSSAA.

Moreover, in step 804, an AMF determines to first perform a registration procedure and put the S-NSSAI in the pending NSSAI sent in a registration accept message transmitted to the UE.

Further, in step 806, the AMF initiates an NSSAA procedure with a transmission towards the UE.

In step 808, if the NSSAA result is EAP success, the AMF initiates an admission check for NSAC and sends a request to a corresponding NSACF for an availability check. In addition, the AMF may indicate to the NSACF to update the number of registered UEs for this S-NSSAI (e.g., combined admission check and update procedure).

Moreover, in step 810, if the reply from the NSACF is positive (e.g., the UE is admitted), the AMF performs a UE configuration update (“UCU”) procedure (e.g., NAS procedure) to include the S-NSSAI in the allowed NSSAI and delete the S-NSSAI from the pending NSSAI.

Further, in step 812, If the UCU procedure fails or is aborted (e.g., due to lower layer failures), the S-NSSAI is not included in the allowed NSSAI and the AMF that has included an indication to update the NSACF, the AMF sends an update request to the NSACF to remove the UE from the registered UEs.

In step 814, if the reply from the NSACF is negative (e.g., the UE is not admitted), the AMF performs the UCU procedure to include the S-NSSAI in the list of rejected S-NSSAI (e.g., with a reject cause value due to failed NSAC and/or optionally a back-off timer).

Moreover, in step 816, if the NSSAA result is EAP failure, the AMF stores the result and performs the UCU procedure with a transmission towards the UE including the S-NSSAI in the list of rejected S-NSSAIs (e.g., with reject cause value due to the failed NSSAA procedure).

In various embodiments, if the UE is registered for a S-NSSAI (e.g., the S-NSSAI is part of the allowed NSSA), and the network initiates re-authentication for NSSAA (e.g., re-NSSAA) procedure, the AMF moves the S-NSSAI from the allowed NSSAI into the pending NSSAI. In such embodiments, it may be determined whether the AMF should update the NSACF due to the ongoing NSSAA procedure. This may be done as follows: 1) option 1: the AMF sends a request to the NSACF to update the status of the UE (e.g., the UE is temporarily not using the S-NSSAI due to the re-NSSAA procedure)—if the AMF sends such a request, the AMF needs to again update the NSACF after the re-NSSAA procedure is completed and the UCU procedure is performed to include the S-NSSAI in the allowed or rejected NSSAI—in other words, the AMF needs to send 2 requests to the NSACF; and/or 2) option 2: the AMF does not send a request to the NSACF due to the re-NSSAA procedure—instead, the AMF executes the re-NSSAA procedure and, depending on the result (e.g., EAP success or failure), the AMF determines whether to include the S-NSSAI in the allowed NSSAI or in the rejected NSSAI—afterwards, the AMF performs the UCU procedure to update the UE configuration—after the UCU procedure, the AMF determines whether to send a request to update the NSACF.

In certain embodiments, if the re-NSSAA procedure is successful (e.g., EAP result is success) and the S-NSSAI is included in the allowed NSSAI, the AMF does not send an update to the NSACF as the NSACF already stores a record that the UE is using the S-NSSAI. In some embodiments, if the re-NSSAA procedure has failed (e.g., EAP result is failure) and the S-NSSAI is included in the rejected NSSAI, the AMF sends an update request to the NSACF to indicate that the UE is not any longer registered with the S-NSSAI.

FIG. 9 shows a procedure for if the S-NSSAI is subject to NSAC for a maximum number of established PDU sessions and if the PDU sessions are also configured to be subject to secondary authentication and/or authorization (“SAA”).

FIG. 9 is a flow chart diagram illustrating one embodiment of a method 900 for if the S-NSSAI is subject to both SAA and NSAC for a maximum number of established PDU sessions.

In step 902, a UE requests a PDU session establishment for an S-NSSAI subject to: to NSAC for a maximum number of PDU sessions; and a PDU session is subject to secondary authentication.

Moreover, in step 904, an SMF determines to perform the secondary authentication and/or authorization (“SAA”) for the PDU session.

Further, in step 906, if the SAA result is success, the SMF initiates an admission check for NSAC and sends the request to a corresponding NSACF for an availability check. In addition, the SMF may indicate to the NSACF to update the number of PDU sessions for this S-NSSAI (e.g., combined admission check and update procedure). This step is performed before the request to establish AN resources.

In step 908, if the reply from the NSACF is positive (e.g., the PDU session is admitted), the SMF continues with the PDU session establishment procedure.

Moreover, in step 910, if the PDU session establishment fails (e.g., due to 5G-AN not being accepted) and the SMF has included an indication to update the NSACF (e.g., combined procedure), the SMF sends an update request to the NSACF to remove the PDU session from the counted established PDU sessions for the S-NSSAI. Further, in step 912, if the reply from the NSACF is negative (e.g., the PDU session

is not admitted), the SMF rejects the PDU session establishment (e.g., with a reject cause value due to a failed NSAC and/or optionally a back-off timer).

In step 914, if the SAA result is failure, the SMF rejects the PDU session establishment (e.g., with a reject cause value due to a failed SAA).

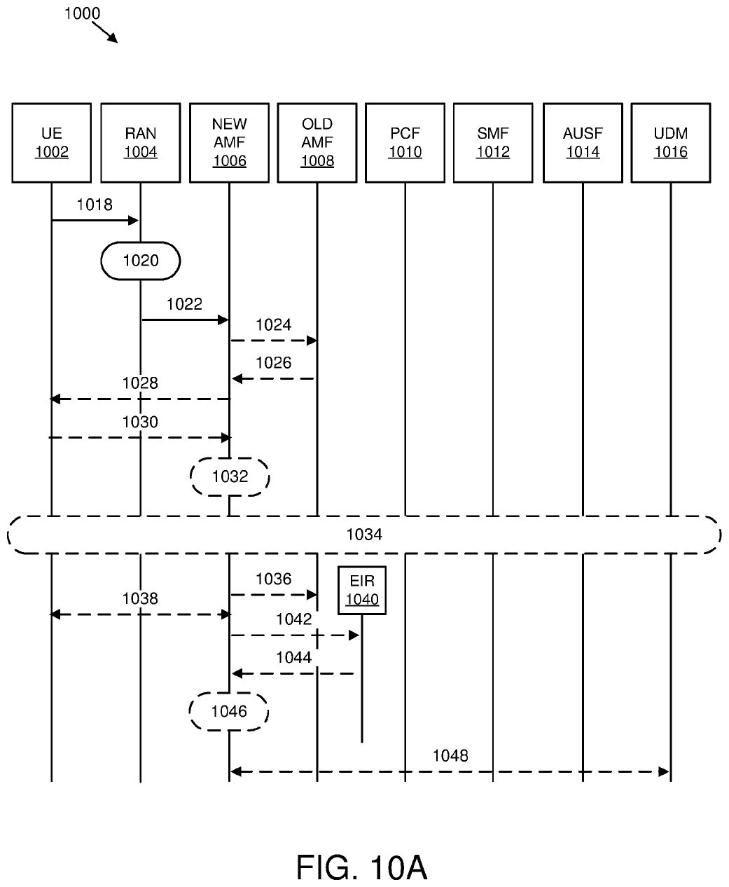

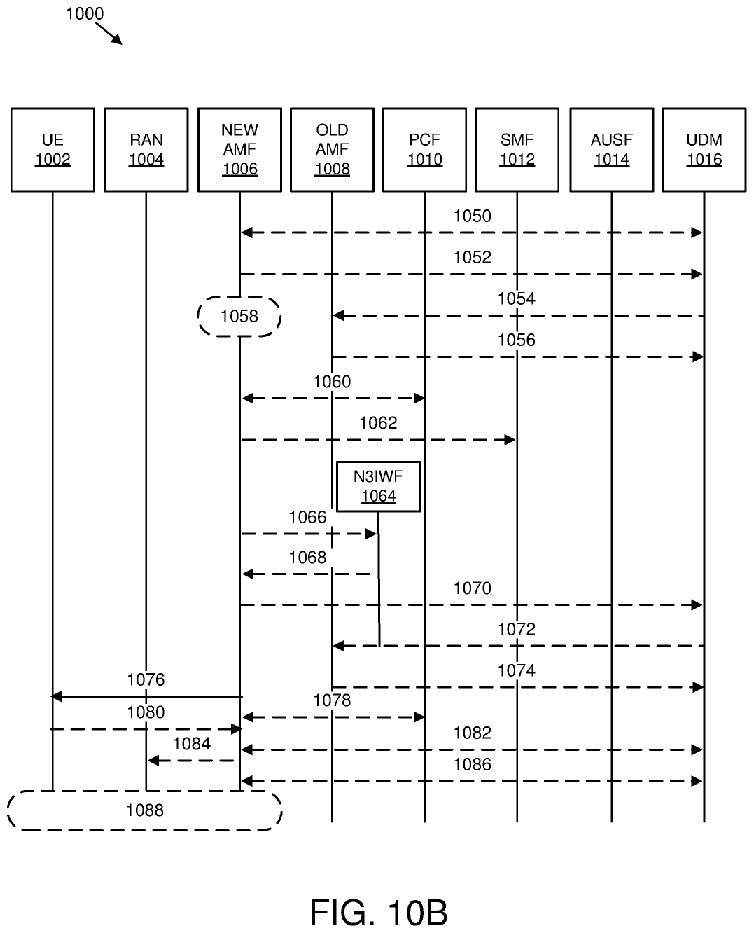

FIGS. 10A through 10B are schematic block diagrams illustrating one embodiment of a system 1000 for performing a registration procedure. The system 1000 includes a UE 1002, a RAN 1004, a new AMF 1006, an old AMF 1008, a PCF 1010, an SMF 1012, an AUSF 1014, and a UDM 1016. Each of the communications in the system 1000 may include one or more messages.

In a first communication 1018, a registration request is transmitted. Then, the RAN 1004 performs 1020 an AMF selection. In a second communication 1022, a registration request is transmitted to the new AMF 1006. In a third communication 1024, an Namf_Communication_UEContextTransfer message is transmitted. Further, in a fourth communication 1026, an Namf_Communication_UEContextTransfer response message is transmitted. Moreover, in a fifth communication 1028, an identity request is communicated. In a sixth communication 1030, an identity response is communicated. Then, the new AMF 1006 performs 1032 AUSF selection.

In a seventh communication 1034, authentication and/or security messages are transmitted.

In an eighth communication 1036, the new AMF 1006 makes a transmission to the old AMF 1008. The transmission includes a Namf_Communication_RegistrationStatusUpdate message (e.g., PDU session IDs to be released due to slice not supported, S-NSSAIs not registered). If the AMF has changed, the new AMF 1006 informs the old AMF 1008 that the registration of the UE 1002 in the new AMF 1006 is completed by invoking the Namf_Communication_RegistrationStatusUpdate service operation. Moreover, if the authentication and/or security procedure fails, then the registration shall be rejected, and the new AMF invokes the Namf_Communication_RegistrationStatusUpdate service operation with a reject indication towards the old AMF 1008. The old AMF 1008 continues as if the UE context transfer service operation was never received.

In certain embodiments, if one or more of the S-NSSAIs used in the old registration area cannot be served in the target registration area, the new AMF 1006 determines which PDU session cannot be supported in the new registration Area. The new AMF 1006 invokes the Namf_Communication_RegistrationStatusUpdate service operation including the rejected PDU session ID towards the old AMF 1008. Then the new AMF 1006 modifies the PDU session status correspondingly. The old AMF 1008 informs the corresponding SMFs to locally release the UE's session management (“SM”) context by invoking the Nsmf_PDUSession_ReleaseSMContext service operation.

In some embodiments, if one or more of the S-NSSAIs part of the allowed NSSAI from the UE context received from the old AMF 1008 are not part of the new allowed NSSAI, the new AMF 1006 invokes the Namf_Communication_RegistrationStatusUpdate service operation including the list of S-NSSAIs that were part of the old allowed NSSAI, but not part of the new allowed NSSAI. The S-NSSAIs may be subject to NSAC for a maximum number of UEs or a maximum number of PDU sessions. If the S-NSSAIs are subject to NSAC, the old AMF 1008 triggers an update procedure towards the corresponding NSACF serving the S-NSSAIs to indicate to the NSACF that the UE is deregistered from the S-NSSAIs. In various embodiments, the old AMF 1008 indicates a new current number of UEs registered with the S-NSSAI in the old AMF 1008. The NSACF reduces the number of UEs registered with the S-NSSAI.

In certain embodiments, if one or more of the S-NSSAIs are subject to NSAC for a maximum number of PDU sessions, the old AMF 1008: 1) for each S-NSSAI subject to NSAC, the old AMF 1008 informs the NSACF to reduce the number of PDU sessions for the UE 1002; and/or 2) the old AMF 1008 informs each corresponding SMF serving a PDU session associated with the S-NSSAI to locally release the PDU. The SMF informs the NSACF about the release PDU sessions or reports the new reduced number of PDU sessions. It should be noted that the reason that some S-NSSAIs are not part of the new allowed NSSAI may be that these slices are not supported in the new registration area or the new AMF 1006 does not support the S-NSSAIs, or the new AMF 1006 does not support NSAC.

In some embodiments, if the new AMF 1006 received in the UE context transfer the information about the AM policy association and the UE policy association and decides, based on local policies, not to use the PCFs identified by the PCF IDs for the AM policy association and the UE policy association, then it will inform the old AMF 1006 that the AM policy association and the UE policy association in the UE context is not used any longer and then the PCF selection is performed.

In a nineth communication 1038, an identity request and/or response are communicated. Further, in a tenth communication 1042 and/or in an eleventh communication 1044, a N5g-eir_EquipmentIdentityCheck_Get message and/or response are communicated with an equipment identity register (“EIR”) 1040. The new AMF 1006 performs 1046 UDM selection. In a twelfth communication 1048, a Nudm_UECM_Registration message is transmitted. Moreover, in a thirteenth communication 1050, a Nudm_SDM_Get message is transmitted. Further, in a fourteenth communication 1052, a Nudm_SDM_subscribe message is transmitted.

In a fifteenth communication 1054, a Nudm_UECM_DeregistrationNotification message is transmitted. Moreover, in a sixteenth communication 1056, a Nudm_SDM_Unsubscribe message is transmitted. The new AMF 1006 performs 1058 PCF selection. Further, in a seventeenth communication 1060, AM policy association establishment and/or modification is performed. In an eighteenth communication 1062, a Nsmf_PDUSession_Update SMContext message and/or a Nsmf_PDUSession_ReleaseSMContext message are transmitted.

In a nineteenth communication 1066 and/or in a twentieth communication 1068, a UE context modification request message and a UE context modification response message are communicated with a non-3GPP interworking function (“N3IWF”) 1064 (and/or TNGF and/or wireless (“W”) access gateway function (“AGF”) (“W-AGF”)). In a twenty-first communication 1070, a Nudm_UECM_Registration message is transmitted. Further, in a twenty-second communication 1072, a Nudm_UECM_DeregistrationNotify message is transmitted. Moreover, in a twenty-third communication 1074, a Nudm_SDM_Unsubscribe message is transmitted.

In a twenty-fourth communication 1076, a registration accept message is transmitted. Further, in a twenty-fifth communication 1078, UE policy association establishment is performed. Moreover, in a twenty-sixth communication 1080, a registration complete message is transmitted. In a twenty-seventh communication 1082, a Nudm_SDM_Info message is transmitted. Further, in a twenty-eighth communication 1084, an N2 message is transmitted. Moreover, in a twenty-nineth communication 1086, an Nudm_UECM_Update message is transmitted. In a thirtieth communication 1088, network slice-specific authentication and authorization is performed.

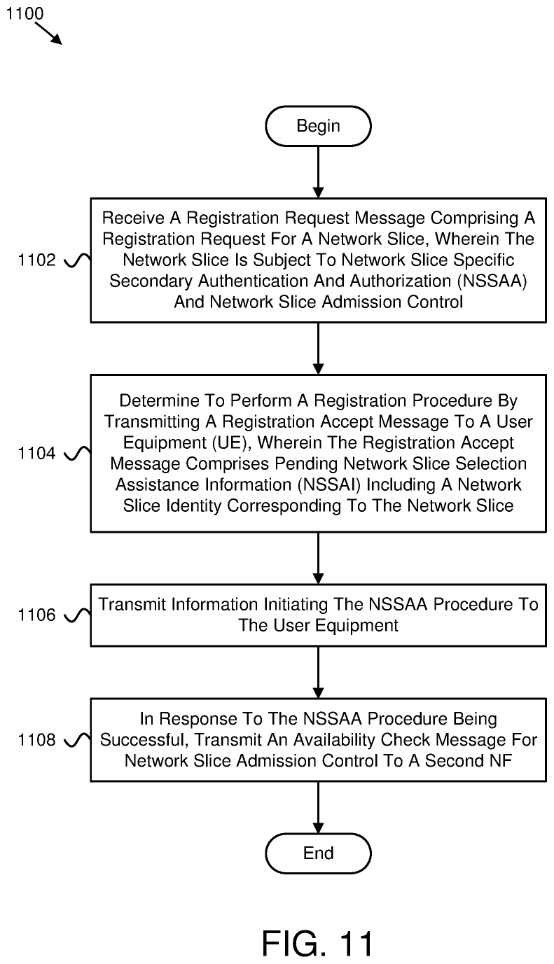

FIG. 11 is a flow chart diagram illustrating one embodiment of a method 1100 for network slice admission control. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes receiving 1102, at a first network function (NF), a registration request message including a registration request for a network slice. The network slice is subject to network slice specific secondary authentication and authorization (NSSAA) and network slice admission control. In some embodiments, the method 1100 includes determining 1104 to perform a registration procedure by transmitting a registration accept message to a user equipment (UE). The registration accept message includes pending network slice selection assistance information (NSSAI) including a network slice identity corresponding to the network slice. In certain embodiments, the method 1100 includes transmitting 1106 information initiating the NSSAA procedure to the user equipment. In various embodiments, the method 1100 includes, in response to the NSSAA procedure being successful, transmitting 1108 an availability check message for network slice admission control to a second NF.

In certain embodiments, the first NF comprises an access and mobility management function (AMF). In some embodiments, the second NF comprises a network slice admission control function (NSACF). In various embodiments, the availability check message comprises information indicating to update a number of registered UEs for the NSSAI.

In one embodiment, the method 1100 further comprises, in response to the NSSAA procedure being unsuccessful, storing a result of the NSSAA procedure. In certain embodiments, the method further comprises, in response to the NSSAA procedure being unsuccessful, transmitting a configuration update to the UE, wherein the configuration update comprises a rejected NSSAI including the network slice. In some embodiments, the rejected NSSAI including the network slice further comprises a reject cause value corresponding to the NSSAA procedure being unsuccessful.

In various embodiments, the method 1100 further comprises receiving a response to the availability check message from the second NF. In one embodiment, the method 1100 further comprises, as a result of the response indicating a failed availability check, transmitting a configuration update to the UE, wherein the configuration update comprises a rejected NSSAI including the network slice. In certain embodiments, the rejected NSSAI including the network slice further comprises a reject cause value corresponding to the failed availability check.

In some embodiments, the method 1100 further comprises, as a result of the response indicating a successful availability check, transmitting a configuration update to the UE, wherein the configuration update comprises an allowed NSSAI including the network slice. In various embodiments, the method 1100 further comprises removing the network slice from the pending NSSAI. In one embodiment, the method 1100 further comprises, in response to the configuration update being unsuccessful, removing the network slice from the allowed NSSAI.

In certain embodiments, the method 1100 further comprises transmitting an update request message to the second NF indicating to remove the UE from a list of registered UEs. In some embodiments, the network slice is identified by a single NSSAI.

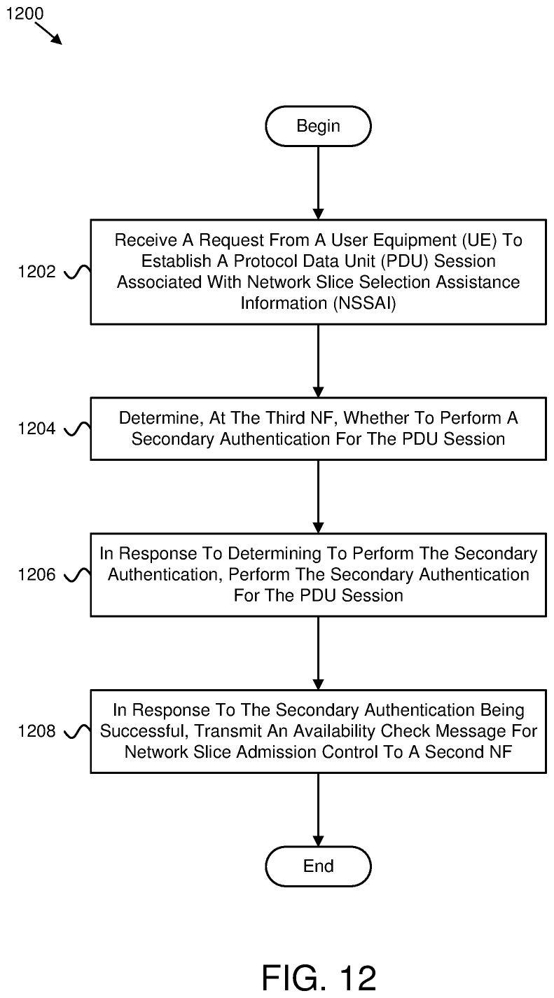

FIG. 12 is a flow chart diagram illustrating another embodiment of a method 1200 for network slice admission control. In some embodiments, the method 1200 is performed by an apparatus, such as the network unit 104. In certain embodiments, the method 1200 may be performed by a processor executing program code, for example, a microcontroller, a microprocessor, a CPU, a GPU, an auxiliary processing unit, a FPGA, or the like.

In various embodiments, the method 1200 includes receiving 1202, at a third network function (NF), a request from a user equipment (UE) to establish a protocol data unit (PDU) session associated with network slice selection assistance information (NSSAI). In some embodiments, the method 1200 includes determining 1204, at the third NF, whether to perform a secondary authentication for the PDU session. In certain embodiments, the method 1200 includes, in response to determining to perform the secondary authentication, performing 1206 the secondary authentication for the PDU session. In various embodiments, the method 1200 includes, in response to the secondary authentication being successful, transmitting 1208 an availability check message for network slice admission control to a second NF.

In certain embodiments, the third NF comprises a session management function (SMF). In some embodiments, the second NF comprises a network slice admission control function (NSACF). In various embodiments, the availability check message comprises information indicating to update a number of PDU sessions for the NSSAI.

In one embodiment, the method 1200 further comprises, in response to the secondary authentication being unsuccessful, transmitting a PDU session establishment failure message to the UE. In certain embodiments, the PDU session establishment failure message comprises a reject cause value corresponding to the secondary authentication being unsuccessful. In some embodiments, the method 1200 further comprises receiving a response to the availability check message from the second NF.

In various embodiments, the method 1200 further comprises, as a result of the response indicating a failed availability check, transmitting a PDU session establishment failure message to the UE. In one embodiment, the PDU session establishment failure message comprises a reject cause value corresponding to the failed availability check.

In certain embodiments, the method 1200 further comprises, as a result of the response indicating a successful availability check, continuing establishment of the PDU session. In some embodiments, the method 1200 further comprises, in response to establishment of the PDU session being unsuccessful, transmitting an update request message to the second NF indicating to remove the PDU session from a list of PDU sessions.

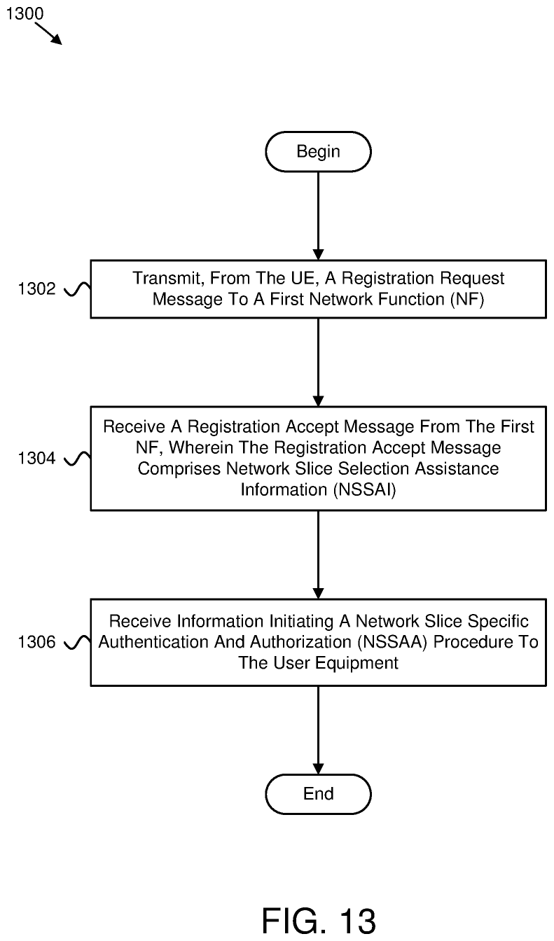

FIG. 13 is a flow chart diagram illustrating a further embodiment of a method 1300 for network slice admission control. In some embodiments, the method 1300 is performed by an apparatus, such as the remote unit 102. In certain embodiments, the method 1300 may be performed by a processor executing program code, for example, a microcontroller, a microprocessor, a CPU, a GPU, an auxiliary processing unit, a FPGA, or the like.

In various embodiments, the method 1300 includes transmitting 1302, from a user equipment (UE), a registration request message to a first network function (NF). In some embodiments, the method 1300 includes receiving 1304 a registration accept message from the first NF. The registration accept message includes network slice selection assistance information (NSSAI). In certain embodiments, the method 1300 includes receiving 1306 information initiating a network slice specific authentication and authorization (NSSAA) procedure to the user equipment.

In certain embodiments, the first NF comprises an access and mobility management function (AMF). In some embodiments, the method 1300 further comprises, in response to the NSSAA procedure being unsuccessful, receiving a configuration update from the first NF, wherein the configuration update comprises the NSSAI in a list of rejected NSSAI. In various embodiments, the configuration update further comprises a reject cause value corresponding to the NSSAA procedure being unsuccessful.

In one embodiment, the method 1300 further comprises, as a result of a failed availability check being performed, receiving a configuration update from the first NF, wherein the configuration update comprises the NSSAI in a list of rejected NSSAI. In certain embodiments, the configuration update further comprises a reject cause value corresponding to the failed availability check. In some embodiments, the method 1300 further comprises, as a result of a successful availability check, receiving a configuration update from the first NF, wherein the configuration update comprises the NSSAI in a list of allowed NSSAI.

In one embodiment, an apparatus comprises a first network function (NF). The apparatus further comprises: a receiver that receives a registration request message comprising a registration request for a network slice, wherein the network slice is subject to network slice specific secondary authentication and authorization (NSSAA) and network slice admission control; a processor that determines to perform a registration procedure by transmitting a registration accept message to a user equipment (UE), wherein the registration accept message comprises pending network slice selection assistance information (NSSAI) including a network slice identity corresponding to the network slice; and a transmitter that: transmits information initiating the NSSAA procedure to the user equipment; and, in response to the NSSAA procedure being successful, transmits an availability check message for network slice admission control to a second NF.

In certain embodiments, the first NF comprises an access and mobility management function (AMF).

In some embodiments, the second NF comprises a network slice admission control function (NSACF).

In one embodiment, the availability check message comprises information indicating to update a number of registered UEs for the NSSAI.

In certain embodiments, the processor, in response to the NSSAA procedure being unsuccessful, stores a result of the NSSAA procedure.

In some embodiments, the transmitter, in response to the NSSAA procedure being unsuccessful, transmits a configuration update to the UE, wherein the configuration update comprises a rejected NSSAI including the network slice.

In various embodiments, the rejected NSSAI including the network slice further comprises a reject cause value corresponding to the NSSAA procedure being unsuccessful.

In one embodiment, the receiver receives a response to the availability check message from the second NF.

In certain embodiments, the transmitter, as a result of the response indicating a failed availability check, transmits a configuration update to the UE, wherein the configuration update comprises a rejected NSSAI including the network slice.

In some embodiments, the rejected NSSAI including the network slice further comprises a reject cause value corresponding to the failed availability check.

In various embodiments, the transmitter, as a result of the response indicating a successful availability check, transmits a configuration update to the UE, wherein the configuration update comprises an allowed NSSAI including the network slice.

In one embodiment, the processor removes the network slice from the pending NSSAI.

In certain embodiments, the processor, in response to the configuration update being unsuccessful, removes the network slice from the allowed NSSAI.

In some embodiments, the transmitter transmits an update request message to the second NF indicating to remove the UE from a list of registered UEs.

In various embodiments, the network slice is identified by a single NSSAI.

In one embodiment, a method for a first network function (NF) comprising: receiving a registration request message comprising a registration request for a network slice, wherein the network slice is subject to network slice specific secondary authentication and authorization (NSSAA) and network slice admission control; determining to perform a registration procedure by transmitting a registration accept message to a user equipment (UE), wherein the registration accept message comprises pending network slice selection assistance information (NSSAI) including a network slice identity corresponding to the network slice; transmitting information initiating the NSSAA procedure to the user equipment; and in response to the NSSAA procedure being successful, transmitting an availability check message for network slice admission control to a second NF.

In certain embodiments, the first NF comprises an access and mobility management function (AMF).

In some embodiments, the second NF comprises a network slice admission control function (NSACF).

In various embodiments, the availability check message comprises information indicating to update a number of registered UEs for the NSSAI.

In one embodiment, the method further comprises, in response to the NSSAA procedure being unsuccessful, storing a result of the NSSAA procedure.

In certain embodiments, the method further comprises, in response to the NSSAA procedure being unsuccessful, transmitting a configuration update to the UE, wherein the configuration update comprises a rejected NSSAI including the network slice.

In some embodiments, the rejected NSSAI including the network slice further comprises a reject cause value corresponding to the NSSAA procedure being unsuccessful.

In various embodiments, the method further comprises receiving a response to the availability check message from the second NF.

In one embodiment, the method further comprises, as a result of the response indicating a failed availability check, transmitting a configuration update to the UE, wherein the configuration update comprises a rejected NSSAI including the network slice.

In certain embodiments, the rejected NSSAI including the network slice further comprises a reject cause value corresponding to the failed availability check.

In some embodiments, the method further comprises, as a result of the response indicating a successful availability check, transmitting a configuration update to the UE, wherein the configuration update comprises an allowed NSSAI including the network slice.

In various embodiments, the method further comprises removing the network slice from the pending NSSAI.

In one embodiment, the method further comprises, in response to the configuration update being unsuccessful, removing the network slice from the allowed NSSAI.

In certain embodiments, the method further comprises transmitting an update request message to the second NF indicating to remove the UE from a list of registered UEs.

In some embodiments, the network slice is identified by a single NSSAI.

In one embodiment, an apparatus comprises a third network function (NF). The apparatus further comprises: a receiver that receives a request from a user equipment (UE) to establish a protocol data unit (PDU) session associated with network slice selection assistance information (NSSAI); a processor that: determines, at the third NF, whether to perform a secondary authentication for the PDU session; and, in response to determining to perform the secondary authentication, performs the secondary authentication for the PDU session; and a transmitter that, in response to the secondary authentication being successful, transmits an availability check message for network slice admission control to a second NF.

In certain embodiments, the third NF comprises a session management function (SMF).

In some embodiments, the second NF comprises a network slice admission control function (NSACF).

In various embodiments, the availability check message comprises information indicating to update a number of PDU sessions for the NSSAI.

In one embodiment, the transmitter, in response to the secondary authentication being unsuccessful, transmits a PDU session establishment failure message to the UE.

In certain embodiments, the PDU session establishment failure message comprises a reject cause value corresponding to the secondary authentication being unsuccessful.

In some embodiments, the receiver receives a response to the availability check message from the second NF.

In various embodiments, the transmitter, as a result of the response indicating a failed availability check, transmits a PDU session establishment failure message to the UE.

In one embodiment, the PDU session establishment failure message comprises a reject cause value corresponding to the failed availability check.

In certain embodiments, the processor, as a result of the response indicating a successful availability check, continues establishment of the PDU session.

In some embodiments, the transmitter, in response to establishment of the PDU session being unsuccessful, transmits an update request message to the second NF indicating to remove the PDU session from a list of PDU sessions.

In one embodiment, a method for a third network function (NF) comprises: receiving a request from a user equipment (UE) to establish a protocol data unit (PDU) session associated with network slice selection assistance information (NSSAI); determining, at the third NF, whether to perform a secondary authentication for the PDU session; in response to determining to perform the secondary authentication, performing the secondary authentication for the PDU session; and in response to the secondary authentication being successful, transmitting an availability check message for network slice admission control to a second NF.

In certain embodiments, the third NF comprises a session management function (SMF).

In some embodiments, the second NF comprises a network slice admission control function (NSACF).

In various embodiments, the availability check message comprises information indicating to update a number of PDU sessions for the NSSAI.

In one embodiment, the method further comprises, in response to the secondary authentication being unsuccessful, transmitting a PDU session establishment failure message to the UE.

In certain embodiments, the PDU session establishment failure message comprises a reject cause value corresponding to the secondary authentication being unsuccessful.

In some embodiments, the method further comprises receiving a response to the availability check message from the second NF.

In various embodiments, the method further comprises, as a result of the response indicating a failed availability check, transmitting a PDU session establishment failure message to the UE.

In one embodiment, the PDU session establishment failure message comprises a reject cause value corresponding to the failed availability check.

In certain embodiments, the method further comprises, as a result of the response indicating a successful availability check, continuing establishment of the PDU session.

In some embodiments, the method further comprises, in response to establishment of the PDU session being unsuccessful, transmitting an update request message to the second NF indicating to remove the PDU session from a list of PDU sessions.

In one embodiment, an apparatus comprises a user equipment (UE). The apparatus further comprises: a transmitter that transmits, from the UE, a registration request message to a first network function (NF); and a receiver that: receives a registration accept message from the first NF, wherein the registration accept message comprises network slice selection assistance information (NSSAI); and receives information initiating a network slice specific authentication and authorization (NSSAA) procedure to the user equipment.

In certain embodiments, the first NF comprises an access and mobility management function (AMF).

In some embodiments, the receiver, in response to the NSSAA procedure being unsuccessful, receives a configuration update from the first NF, wherein the configuration update comprises the NSSAI in a list of rejected NSSAI.

In various embodiments, the configuration update further comprises a reject cause value corresponding to the NSSAA procedure being unsuccessful.

In one embodiment, the receiver, as a result of a failed availability check being performed, receives a configuration update from the first NF, wherein the configuration update comprises the NSSAI in a list of rejected NSSAI.

In certain embodiments, the configuration update further comprises a reject cause value corresponding to the failed availability check.

In some embodiments, the receiver, as a result of a successful availability check, receives a configuration update from the first NF, wherein the configuration update comprises the NSSAI in a list of allowed NSSAI.

In one embodiment, a method for a user equipment (UE) comprises: transmitting, from the UE, a registration request message to a first network function (NF); receiving a registration accept message from the first NF, wherein the registration accept message comprises network slice selection assistance information (NSSAI); and receiving information initiating a network slice specific authentication and authorization (NSSAA) procedure to the user equipment.

In certain embodiments, the first NF comprises an access and mobility management function (AMF).

In some embodiments, the method further comprises, in response to the NSSAA procedure being unsuccessful, receiving a configuration update from the first NF, wherein the configuration update comprises the NSSAI in a list of rejected NSSAI.

In various embodiments, the configuration update further comprises a reject cause value corresponding to the NSSAA procedure being unsuccessful.

In one embodiment, the method further comprises, as a result of a failed availability check being performed, receiving a configuration update from the first NF, wherein the configuration update comprises the NSSAI in a list of rejected NSSAI.

In certain embodiments, the configuration update further comprises a reject cause value corresponding to the failed availability check.

In some embodiments, the method further comprises, as a result of a successful availability check, receiving a configuration update from the first NF, wherein the configuration update comprises the NSSAI in a list of allowed NSSAI.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a first network function (NF), the apparatus comprising:
at least one memory; and
at least one processor coupled with the at least one memory and configured to cause the apparatus to:
receive a registration request message comprising a registration request for a network slice, wherein the network slice is subject to network slice specific secondary authentication and authorization (NSSAA) and network slice admission control;
determine to perform a registration procedure by transmitting a registration accept message to a user equipment (UE), wherein the registration accept message comprises pending network slice selection assistance information (NSSAI) including a network slice identity corresponding to the network slice;
transmit information initiating an NSSAA procedure to the UE; and
in response to the NSSAA procedure being successful, transmit an availability check message for network slice admission control to a second NF.

2. The apparatus of claim 1, wherein the availability check message comprises information indicating to update a number of registered UEs for the NSSAI.

3. The apparatus of claim 1, wherein the at least one processor is configured to cause the apparatus to, in response to the NSSAA procedure being unsuccessful, store a result of the NSSAA procedure.

4. The apparatus of claim 1, wherein the at least one processor is configured to cause the apparatus to, in response to the NSSAA procedure being unsuccessful, transmit a configuration update to the UE, wherein the configuration update comprises a rejected NSSAI including the network slice.

5. The apparatus of claim 4, wherein the rejected NSSAI including the network slice further comprises a reject cause value corresponding to the NSSAA procedure being unsuccessful.

6. The apparatus of claim 1, wherein the at least one processor is configured to cause the apparatus to receive response to the availability check message from the second NF.

7. The apparatus of claim 6, wherein the at least one processor is configured to cause the apparatus to, as a result of the response indicating a failed availability check, transmit a configuration update to the UE, wherein the configuration update comprises a rejected NSSAI including the network slice.

8. The apparatus of claim 7, wherein the rejected NSSAI including the network slice further comprises a reject cause value corresponding to the failed availability check.

9. The apparatus of claim 6, wherein the at least one processor is configured to cause the apparatus to, as a result of the response indicating a successful availability check, transmit a configuration update to the UE, wherein the configuration update comprises an allowed NSSAI including the network slice.

10. The apparatus of claim 9, wherein the at least one processor is configured to cause the apparatus to remove the network slice from the pending NSSAI.

11. The apparatus of claim 9, wherein the at least one processor is configured to cause the apparatus to, in response to the configuration update being unsuccessful, remove the network slice from the allowed NSSAI.

12. The apparatus of claim 11, wherein the at least one processor is configured to cause the apparatus to transmit an update request message to the second NF indicating to remove the UE from a list of registered UEs.

13. The apparatus of claim 1, wherein the network slice is identified by a single NSSAI.

14. An apparatus for performing a third network function (NF), the apparatus further comprising:
at least one memory; and
at least one processor coupled with the at least one memory and configured to cause the apparatus to:
receive a request from a user equipment (UE) to establish a protocol data unit (PDU) session associated with network slice selection assistance information (NSSAI);
determine, at the third NF, whether to perform a secondary authentication for the PDU session;
in response to determining to perform the secondary authentication, perform the secondary authentication for the PDU session; and
in response to the secondary authentication being successful, transmit an availability check message for network slice admission control to a second NF.

15. A user equipment (UE), comprising:
at least one memory; and
at least one processor coupled with the at least one memory and configured to cause the UE to:
transmit, from the UE, a registration request message to a first network function (NF);
receive a registration accept message from the first NF, wherein the registration accept message comprises network slice selection assistance information (NSSAI); and
receive information initiating a network slice specific authentication and authorization (NSSAA) procedure to the user equipment.

16. A processor for wireless communication, comprising:
at least one controller coupled with at least one memory and configured to cause the processor to:
transmit a registration request message to a first network function (NF);
receive a registration accept message from the first NF, wherein the registration accept message comprises network slice selection assistance information (NSSAI); and
receive information initiating a network slice specific authentication and authorization (NSSAA) procedure.

17. The apparatus of claim 14, wherein the third NF comprises a session management function (SMF).

18. The apparatus of claim 14, wherein the second NF comprises a network slice admission control function (NSACF).

19. The apparatus of claim 14, wherein the availability check message comprises information indicating to update a number of PDU sessions for the NSSAI.

20. The apparatus of claim 14, wherein the at least one processor is configured to cause the apparatus to, in response to the secondary authentication being unsuccessful, transmit a PDU session establishment failure message to the UE.
